(19) United States
(12) Patent Application Publication
(10) Pub. No.: US 2004/0164469 A1
(43) Pub. Date: Aug. 26, 2004

(54) Hydraulic antivibration pivot with axial stops, vehicle equipped with such a pivot, and method of producing such a pivot

(76) Inventors: Bernard Bouhier, Noyers Sur Cher (FR); Pascal Carobolante, Saint Hilaire De Court (FR); Pierre Gautier, Bourges (FR)

Correspondence Address: STITES & HARBISON PLLC, 1199 NORTH FAIRFAX STREET, SUITE 900, ALEXANDRIA, VA, 22314, US

(21) Appl. No.: 10/753,873

(22) Filed: Jan. 9, 2004

(30) Foreign Application Priority Data
Jan. 9, 2003 (FR) 03 00182

(51) Int. Cl. F16F 5/00

(52) U.S. Cl. 267/140.11

(57) ABSTRACT

Hydraulic antivibration pivot comprising coaxial internal and external reinforcements connected by an elastomer body that defines two hydraulic chambers communicating with each other through a throttled passage. An intermediate reinforcement embedded in the elastomer body comprises two rigid annuluses about which the external reinforcement is tightened, the said annuluses having collars that project from this reinforcement. The external reinforcement is immobilized between the two collars, which means that axial loads are absorbed without the risk of the pivot becoming detached.

### FIELD OF THE INVENTION

The present invention relates to hydraulic antivibration pivots, to vehicles equipped with such pivots, and to the methods of producing such pivots.

### BACKGROUND OF THE INVENTION

More specifically, the invention relates to a hydraulic antivibration pivot intended to be inserted between a first and a second rigid elements to damp vibrations along at least a first axis, this pivot being designed to be inserted into a housing belonging to the second rigid element, and the said pivot comprising:

an internal rigid reinforcement that extends longitudinally along a second axis perpendicular to the first axis and that is intended to be fixed to the first rigid element,

an external rigid reinforcement that is of a tubular shape centred on the second axis and that surrounds the internal reinforcement, this external reinforcement having a certain inside diameter and a certain outside diameter,

an elastomer body connecting together the internal and external reinforcements while defining with the latter at least two liquid-filled hydraulic chambers, which are situated on each side of the internal reinforcement and which are connected to each other by at least one throttled passage,

and a rigid intermediate reinforcement which is embedded in the elastomer body near the external reinforcement and which is cut away over the hydraulic chambers, this intermediate reinforcement comprising two rigid annuluses which are centred on the second axis and which frame the hydraulic chambers axially, the external reinforcement gripping these two rigid annuluses and sealing the hydraulic chambers, in which pivot the intermediate reinforcement comprises, beyond the two rigid annuluses a first and a second collars that extend radially outwards, thereby forming two shoulders oriented axially towards the two annuluses, the external reinforcement being retained between these shoulders without play, in which pivot the first and second collars have a radial size that is greater than the inside diameter of the external reinforcement and thus act as axial stops for the external reinforcement, in which pivot the outside diameter of the external reinforcement is greater than the radial size of at least the first collar, in which pivot the first and second collars are covered with an elastomer layer belonging to the elastomer body.

Document U.S. Pat. No. 5,711,513 discloses an example of a pivot of this type.

### OBJECTS AND SUMMARY OF THE INVENTION

It is a particular object of the present invention to facilitate the fitting of such pivots in such a way that there is an absence of radial play between the external reinforcement and the element in which it is mounted.

To this end, according to the invention, a hydraulic pivot of the type in question is characterized in that the outside diameter of the external reinforcement is greater than the radial size of the elastomer layer covering the first collar.

By means of these arrangements, the pivot can be inserted into a reception housing, and the direct contact between the external reinforcement and the wall of the housing ensures that there is no play even if vibrations occur.

Optionally, the inside diameter of the external reinforcement may be at least 0.5 mm less than the radial size of the first and second collars. The invention also relates to a motor vehicle comprising a rear axle assembly equipped with arms designed to connect this rear axle assembly to the rest of the chassis, each rigid arm having an annular wall that defines at least one housing in which a hydraulic antivibration pivot as defined above is engaged, the external reinforcement being in direct radial contact with the said annular wall.

Preferred embodiments of the motor vehicle according to the invention may optionally also employ one or other of the following provisions:

the external reinforcement is inserted tightly into the housing;

the antivibration pivot is mounted across between two parallel end plates, these being arranged perpendicularly to the second axis and belonging to the first rigid element;

the second collar has a radial size greater than the outside diameter of the external reinforcement and bears on the rigid part defining the housing.

Lastly, the invention also relates to a method of producing an antivibration pivot as defined above, comprising the following steps:

a) moulding the elastomer body onto the internal reinforcement and the intermediate reinforcement,

b) engaging on the elastomer body a metal tube having no elastomer and having an inside width greater than the radial size of one of the two shoulders formed by the two collars covered with a layer of elastomer belonging to the said elastomer body,

c) positioning the metal tube between the two shoulders,

d) and then contracting the metal tube to create the external reinforcement of the support, gripping the first and second annuluses of the intermediate reinforcement in order on the one hand to immobilize the external reinforcement between the two shoulders and on the other hand to seal the two hydraulic chambers.

Advantageously, step (d) takes place in a liquid bath that fills the hydraulic chambers.

### SHORT DESCRIPTION OF THE DRAWINGS

Other features and advantages of the invention will become apparent in the course of the following description of an embodiment given by way of non-restrictive example, with reference to the appended drawings.

In the drawings:

FIG. 1 is a diagrammatic view of a motor vehicle comprising a rear axle assembly equipped with arms comprising hydraulic antivibration pivots according to the invention,

FIG. 2 is a perspective view of the rear axle assembly equipped with two antivibration pivots according to one embodiment of the invention, for the vehicle shown in FIG. 1,

FIG. 3 shows one of the antivibration pivots of FIG. 2 mounted, by way of example, between end plates connected to the body of the vehicle,

FIG. 4 is a vertical cross section taken on IV-IV as marked in FIG. 3, through one of the hydraulic antivibration pivots that can be fitted to the arms of the axle assembly of FIG. 2, in one embodiment of the invention,

FIG. 5 is a cross section taken on V-V as marked in FIG. 4,

FIG. 6 is a view showing the hydraulic antivibration pivot at an intermediate stage in its manufacture,

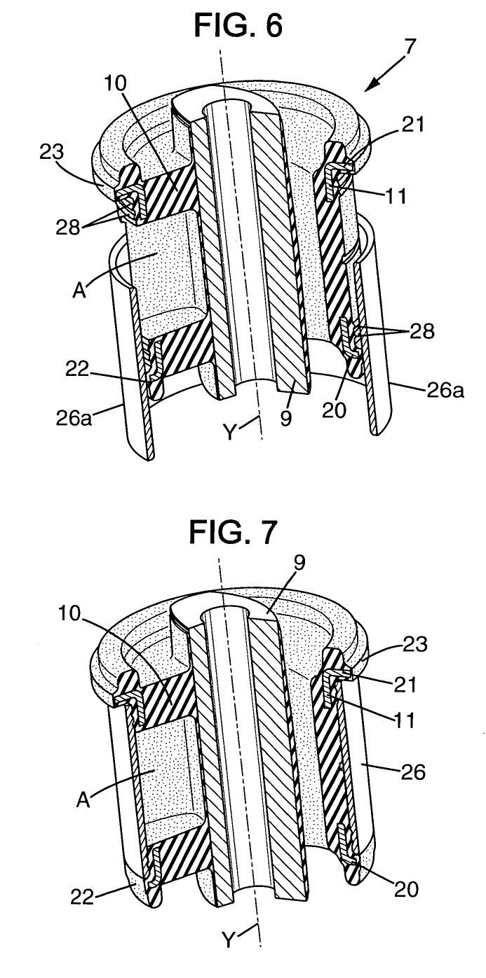

and FIG. 7 is a view similar to that of FIG. 6 and showing the hydraulic antivibration pivot in its final form.

### MORE DETAILED DESCRIPTION

In the various figures, identical references denote identical or similar parts.

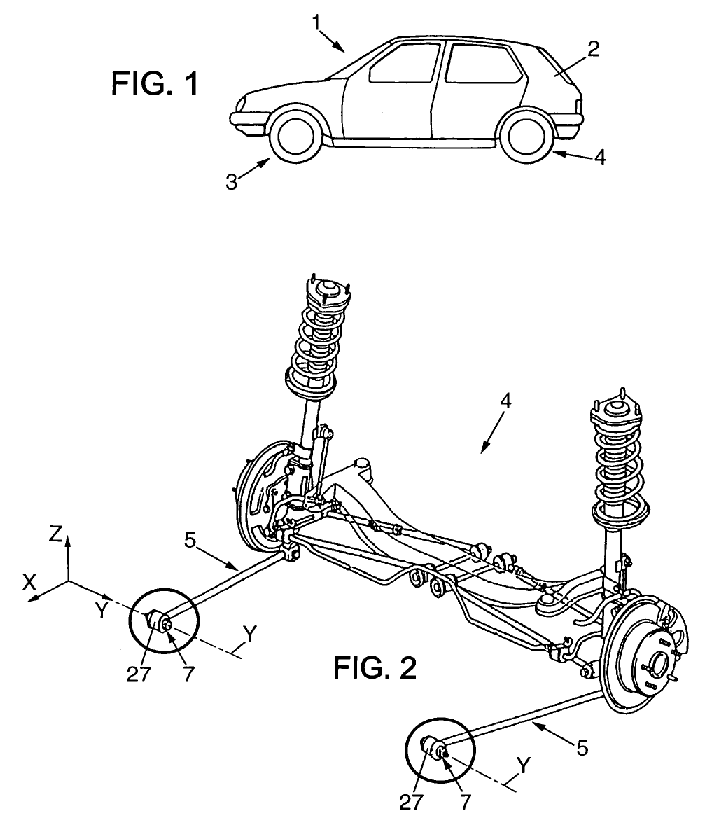

FIG. 1 shows a motor vehicle 1 with a body 2 supported by a front axle assembly 3 and a rear axle assembly 4.

As shown in FIG. 2, the rear axle assembly 4 may have longitudinal arms 5 whose front ends are connected to the body 2 of the vehicle by way of hydraulic antivibration pivots 7 engaged in housings in the said arms formed in cylindrical rings 27 of axis Y parallel to the transverse horizontal direction Y of the vehicle.

The hydraulic antivibration pivots 7 constitute flexible connections that allow a certain amount of play between the body 2 and an arm 5 along the transverse axis Y, the longitudinal horizontal axis X of the vehicle and the vertical axis Z of the vehicle, while damping relative vibrational movements between the arm 5 and the body 2 particularly along the axis X.

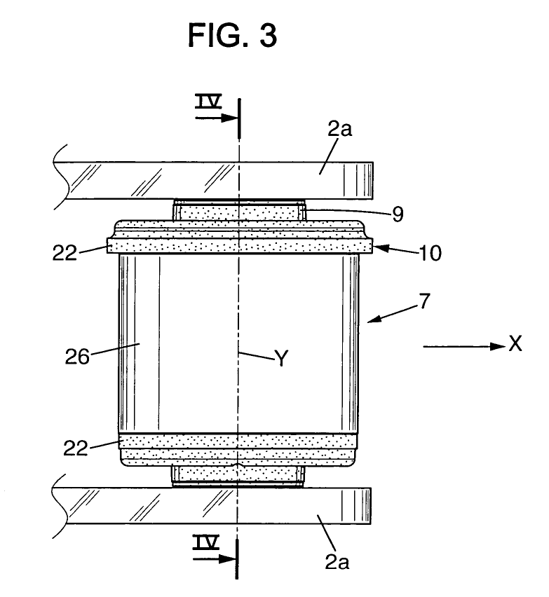

As shown in FIG. 3, the hydraulic antivibration pivot 7, and more precisely the internal metal reinforcement 9 of this pivot may for example be mounted across between two end plates 2a attached to the body 2 of the vehicle.

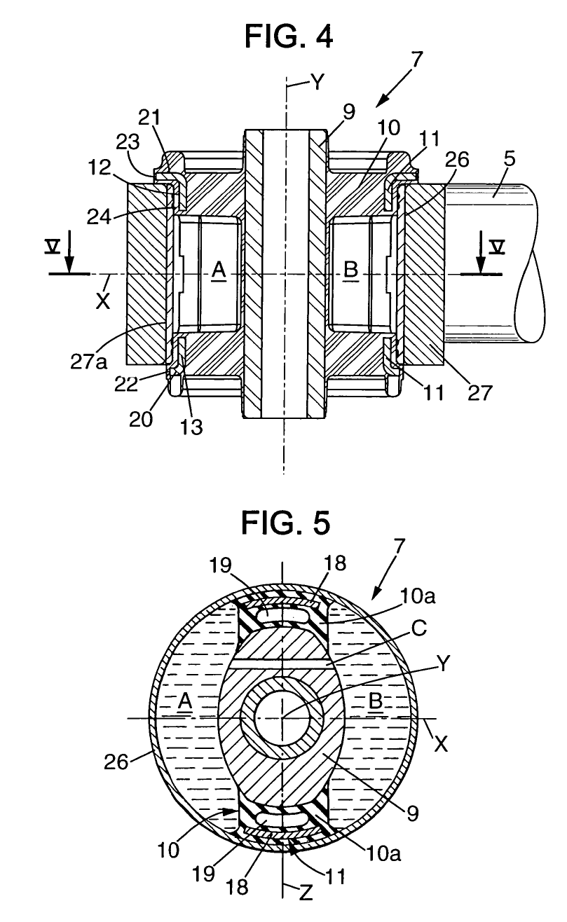

As shown in FIGS. 4 and 5, the internal rigid metal reinforcement 9 extends longitudinally along the transverse axis Y and is intended to be fixed to the body 2 of the vehicle.

Overmoulded and bonded to this internal reinforcement is an elastomer body 10 partially defining two hydraulic chambers A, B, that are located on each side of the internal reinforcement 9 and are connected to each other by a throttled channel C formed through the said internal reinforcement 9 or formed in some other way.

Embedded in the elastomer body 10 is a rigid intermediate reinforcement 11 which takes the form of, for example, a metal part having axisymmetry about the axis Y. This intermediate reinforcement is interrupted by the hydraulic chambers A, B to allow these chambers to be formed during moulding of the elastomer body 10.

The intermediate reinforcement 11 thus forms:

two rigid annuluses 12, 13 which are centred on the axis Y and are arranged axially on each side of the hydraulic chambers A, B

and also two vertical bridges 18 that connect together the two annuluses 12, 13 in the part 10a of the elastomer body forming a partition between the two hydraulic chambers A, B. Each partition may optionally be provided with a recess 19 in the form of a well that extends longitudinally along the axis Y, in order to increase the vertical flexibility of the pivot 7.

In addition, the annuluses 12, 13 are each continued, at their end furthest from the hydraulic chambers, by a collar 20, 21 which extends radially outwards so that each forms a shoulder.

A relatively fine layer of elastomer 22, 23 belonging to the elastomer body 10 may optionally entirely cover each collar 20, 21.

Lastly, an external tubular reinforcement 26, preferably made of metal only with no elastomer overmoulding, grips the two annuluses 12, 13 and closes the chambers A, B. The external tubular reinforcement 26 has an inside diameter that is less than the radial size of the two collars 20, 21 and an outside diameter that is greater than the radial size of the elastomer layer covering the collar 20. The second collar 21 has a radial size that is greater than the outside diameter of the external reinforcement 26.

The antivibration pivot 7 constructed in this way is inserted vertically into the abovementioned cylindrical ring 27 until the shoulder formed by the collar 21 covered with its elastomer layer rests on one of the end faces of the ring 27.

The housing 27a defined by the ring 27 advantageously has an inside diameter approximately equal to the outside diameter of the external reinforcement 26, so that the external reinforcement 26 is a tight fit inside the housing.

In this way the antivibration pivot 7 absorbs axial loads without the risk of the external reinforcement 26 sliding off the elastomer body, because the external reinforcement 26 is prevented from moving in both directions by the collars 20, 21.

The hydraulic antivibration pivot 7 described above can be produced, for example, in the following manner:

the elastomer body 10 is moulded and cured on the internal reinforcement 9 and on the intermediate reinforcement 11,

onto the elastomer body (10), there is fitted a metal tube 26a having no elastomer and having an inside width greater than or equal to the radial size of the shoulder formed by the collar 20 in its elastomer layer 22, which belongs to the said elastomer body (FIG. 6),

the metal tube (26a) is then positioned between the two shoulders,

and, with the elastomer body (10) and the metal tube (26a) placed in a liquid bath, the metal tube is contracted to produce the external reinforcement (26) of the support, gripping the first and second annuluses (12, 13) of the intermediate reinforcement so as on the one hand to prevent any movement at all of the external reinforcement between the two shoulders and on the other hand to seal the two hydraulic chambers (A, B) (FIG. 7).

The elastomer layer 22, 23 covering the two collars 20, 21 preferably includes annular ribs 28 forming sealing lips (see FIG. 6), which are at least partly compressed during contraction of the tube 26a.

We claim:

1. Hydraulic antivibration pivot intended to be inserted between a first and a second rigid elements to damp vibrations along at least a first axis, this pivot being designed to be inserted into a housing belonging to the second rigid element, and the said pivot comprising:
an internal rigid reinforcement that extends longitudinally along a second axis perpendicular to the first axis and that is intended to be fixed to the first rigid element,
an external rigid reinforcement that is of a tubular shape centred on the second axis and that surrounds the internal reinforcement, this external reinforcement having a certain inside diameter and a certain outside diameter,
an elastomer body connecting together the internal and external reinforcements while defining with the latter at least two liquid-filled hydraulic chamber, which are situated on each side of the internal reinforcement and which are connected to each other by at least one throttled passage,
and a rigid intermediate reinforcement which is embedded in the elastomer body near the external reinforcement and which is cut away over the hydraulic chambers, this intermediate reinforcement comprising two rigid annuluses which are centred on the second axis and which frame the hydraulic chambers axially, the external reinforcement gripping these two rigid annuluses and sealing the hydraulic chambers, in which pivot the intermediate reinforcement comprises, beyond the two rigid annuluses a first and a second collars that extend radially outwards, thereby forming two shoulders oriented axially towards the two annuluses, the external reinforcement being retained between these shoulders without play, in which pivot the first and second collars have a radial size that is greater than the inside diameter of the external reinforcement and thus act as axial stops for the external reinforcement, in which pivot the outside diameter of the external reinforcement is greater than the radial size of at least the first collar, in which pivot the first and second collars are covered with an elastomer layer belonging to the elastomer body, wherein the outside diameter of the external reinforcement is greater than the radial size of the elastomer layer covering the first collar.

2. Hydraulic antivibration pivot according to claim 1, in which the inside diameter of the external reinforcement is at least 0.5 mm less than the radial size of the first and second collars.

3. Motor vehicle comprising an axle assembly equipped with two rigid arms, each rigid arm having an annular wall that defines at least one housing in which a hydraulic antivibration pivot according to claim 1 is engaged, the external reinforcement being in direct radial contact with the said annular wall.

4. Motor vehicle according to claim 3, in which the external reinforcement is inserted tightly into the housing.

5. Motor vehicle according to claim 3, in which the antivibration pivot is mounted across between two parallel end plates, these being arranged perpendicularly to the second axis and belonging to the first rigid element.

6. Motor vehicle according to claim 3, in which the second collar has a radial size greater than the outside diameter of the external reinforcement and bears against the rigid arm.

7. Method of producing a hydraulic antivibration pivot according to claim 1, comprising the following steps:
a) moulding the elastomer body onto the internal reinforcement and the intermediate reinforcement,
b) engaging on the elastomer body a metal tube having no elastomer and having an inside width greater than the radial size of one of the two shoulders formed by the two collars,
c) positioning the metal tube between the two shoulders,
d) and then contracting the metal tube to create the external reinforcement of the support, gripping the first and second annuluses of the intermediate reinforcement in order on the one hand to immobilize without play the external reinforcement between the two shoulders and on the other hand to seal the two hydraulic chambers.

8. Production method according to claim 7, in which step takes place in a liquid bath that fills the hydraulic chambers.
